(19) United States
(12) Patent Application Publication
(10) Pub. No.: US 2011/0021193 A1
(43) Pub. Date: Jan. 27, 2011

(54) MOBILE STATION, TRANSMISSION RELAY, BASE STATION, AND METHOD FOR TRANSFERRING DATA USING CONNECTION IDENTIFIER IN MULTI-HOP RELAY SYSTEM

(75) Inventor: Sung Jin HONG, Hwaseong-si (KR)

Correspondence Address: H.C. PARK & ASSOCIATES, PLC, 8500 LEESBURG PIKE, SUITE 7500, VIENNA, VA, 22182, US

(73) Assignee: Pantech Co., Ltd., Seoul (KR)

(21) Appl. No.: 12/689,057

(22) Filed: Jan. 18, 2010

(30) Foreign Application Priority Data
Jul. 27, 2009 (KR) 10-2009-0068229

(51) Int. Cl. H04W 60/00; H04B 7/14

(52) U.S. Cl. 455/435.1; 455/7

(57) ABSTRACT

A Connection Identifier (CID) including an ID of a base station and an ID of a transmission relay is assigned to a mobile station by a transmission relay to transmit and receive information among the mobile station and the base station via the transmission relay. A mobile station includes a receiving unit to receive a CID from a transmission relay connected to a base station, the CID assigned by the transmission relay and including an ID of the base station and ID of the transmission relay; and a transmission unit to transmit data to the base station through the transmission relay based on the CID. The transmission relay includes a CID assignment unit to assign the CID to the mobile station.

### CROSS-REFERENCE TO RELATED APPLICATION

This application claims priority from and the benefit of Korean Patent Application No. 10-2009-0068229, filed on Jul. 27, 2009, which is hereby incorporated by reference for all purposes as if fully set forth herein.

### BACKGROUND

1. Field of the Invention

Embodiments of the present invention relate to a mobile communication, and more particularly, to a data transmission system that may use a connection identifier to transmit data through relays.

2. Discussion of the Background

A base station may transmit data to a mobile station located in a coverage assigned to each respective base station. A base station may use a relay to extend a coverage. A base station may transmit data to a mobile station through multiple relays as well as a single relay.

A base station may identify a data transmission link between the base station and a mobile station using a connection identifier (CID). A mobile station may move within a coverage of a base station. In this instance, a mobile station receiving the data from the base station via a first relay may receive data from the base station via a second relay as the location of the mobile station changes.

In a conventional art, a mobile station may transmit, to a base station, a CID assignment request for a new data transmission link including a second relay. The base station may assign a CID for the new data transmission link, and transmit the assigned CID to the mobile station.

In a conventional art, since a base station assigns a CID, a significant time delay may occur when of the mobile station moves among the relays.

### SUMMARY

Exemplary embodiments of the present invention provide a connection identifier (CID) that may include an ID of a base station and an ID of a transmission relay. Exemplary embodiments of the present invention also provide a mobile station, a transmission relay, and a base station, and a method for transferring data using the CID.

Additional features of the invention will be set forth in the description which follows, and in part will be apparent from the description, or may be learned by practice of the invention.

An exemplary embodiment of the present invention discloses a mobile station, including a receiving unit to receive a CID from a first transmission relay connected to a base station, the CID assigned by the first transmission relay and including an ID of the base station and ID of the first transmission relay; and a transmission unit to transmit data to the base station through the first transmission relay based on the CID.

An exemplary embodiment of the present invention discloses a transmission relay connected to a base station, the transmission relay including a CID assignment unit to assign a CID to a mobile station, the CID including an ID of the base station and an ID of the transmission relay; and a transmission unit to transmit the CID to the mobile station and to transmit data to the mobile station based on the CID, the data being received from the base station.

An exemplary embodiment of the present invention discloses a base station, including a receiving unit to receive first data from a mobile station through a first transmission relay connected to the base station; and a transmission unit to transmit second data to the mobile station using a CID assigned by the first transmission relay and including an ID of the first transmission relay and an ID of the base station.

An exemplary embodiment of the present invention discloses a data transmission method including receiving a CID from a first transmission relay connected to a base station, the CID assigned by the first transmission relay and including an ID of the base station and ID of the first transmission relay, and transmitting data to the base station through the first transmission relay based on the CID.

An exemplary embodiment of the present invention discloses a data forwarding method, including at a transmission relay connected to a base station, assigning a CID to a mobile station, the CID including an ID of the base station and an ID of the transmission relay, transmitting the CID to the mobile station, and forwarding data received from the base station to the mobile station based on the CID.

An exemplary embodiment of the present invention discloses a data receiving method, including receiving a CID from a transmission relay connected to a base station, the CID assigned by the transmission relay and including an ID of the base station and ID of the transmission relay, and receiving data from a mobile station through the transmission relay using the CID.

An exemplary embodiment of the present invention discloses a computer-readable recording medium storing a program for implementing a data transmission method, the method including receiving a CID from a transmission relay connected to a base station, the CID assigned by the transmission relay and including an ID of the base station and ID of the transmission relay, and transmitting data to the base station through the transmission relay based on the CID.

An exemplary embodiment of the present invention discloses a computer-readable recording medium storing a program for implementing a data forwarding method, the method including at a transmission relay connected to a base station, assigning a CID to a mobile station, the CID including an ID of the base station and an ID of the transmission relay, transmitting the CID to the mobile station, and forwarding data received from the base station to the mobile station based on the CID.

An exemplary embodiment of the present invention discloses computer-readable recording medium storing a program for implementing a data receiving method, including receiving a CID from a transmission relay connected to a base station, the CID assigned by the transmission relay and including an ID of the base station and ID of the transmission relay, and receiving data from a mobile station through the transmission relay using the CID.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a data transmission system according to an exemplary embodiment of the present invention.

FIG. 2 is a diagram illustrating a configuration of a connection identifier (CID) according to an exemplary embodiment of the present invention.

FIG. 3 is a diagram illustrating an example of a connection priority according to an exemplary embodiment of the present invention.

FIG. 4 is a diagram illustrating an example of reassigning a CID when a mobile station moves within a coverage according to an exemplary embodiment of the present invention.

FIG. 5 is a flowchart illustrating a CID assignment method according to an exemplary embodiment of the present invention.

FIG. 6 is a flowchart illustrating a CID assignment method according to an exemplary embodiment of the present invention.

FIG. 7 is a block diagram illustrating a configuration of a mobile station according to an exemplary embodiment of the present invention.

FIG. 8 is a block diagram illustrating a configuration of a transmission relay according to an exemplary embodiment of the present invention.

FIG. 9 is a block diagram illustrating a configuration of a base station according to an exemplary embodiment of the present invention.

FIG. 10 is a flowchart illustrating a data transmission method according to an exemplary embodiment of the present invention.

FIG. 11 is a flowchart illustrating a data forwarding method according to an exemplary embodiment of the present invention.

FIG. 12 is a flowchart illustrating a data receiving method according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

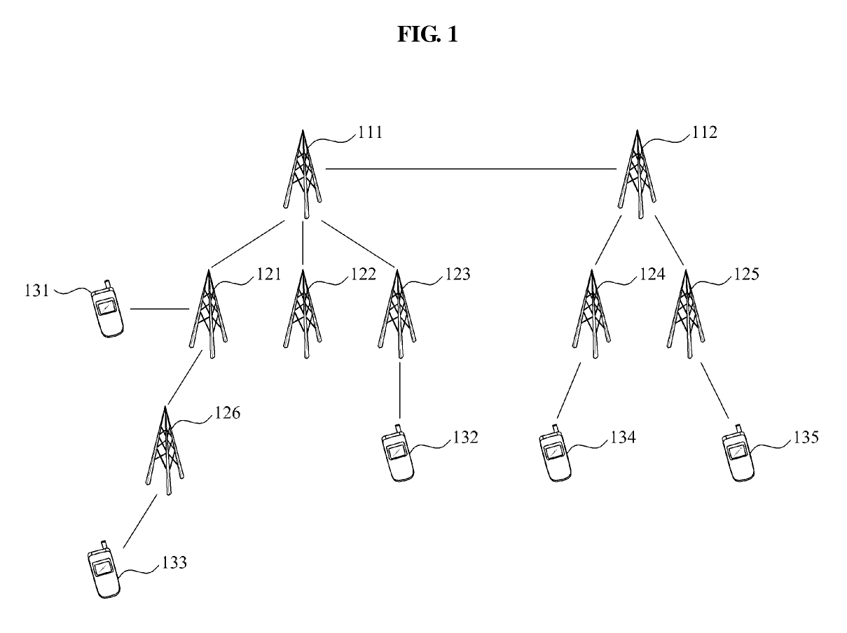

FIG. 1 is a diagram illustrating a data transmission system according to an exemplary embodiment of the present invention.

A first base station (BS) 111 and a second BS 112 may receive data from mobile stations (MSs) 131, 132, 133, 134, and 135. When the MSs 131, 132, 133, 134, and 135 are located within a coverage of first BS 111 or the second BS 112, the MSs 131, 132, 133, 134, and 135 may send and receive data directly from the first BS 111 or the second BS 112, respectively.

When the first BS 111 and the second BS 112 use relays 121, 122, 123, 124, 125, and 126, the coverage of the first BS 111 and the second BS 112 may be extended. Accordingly, although the MSs 131, 132, 133, 134, and 135 may be outside the original coverage of the first BS 111 and the second BS 112, the MSs 131, 132, 133, 134, and 135 may be located within an extended coverage created by relays 121, 122, 123, 124, 125, and 126, and may transmit data to the first BS 111 or the second BS 112 using data links as shown.

The first BS 111 and the second BS 112 identify data links associated with the MSs 131, 132, 133, 134, and 135 to transmit the data to the respective MSs 131, 132, 133, 134, and 135. For example, the first BS 111 may identify a first data link associated with the first MS 131, and a third data link associated with the third MS 133. The first data link may be among the first MS 131, the first relay 121, and the first BS 111, and the third data link may be among the third MS 133, the sixth relay 126, the first relay 121, and the first BS 111.

The first BS 111 and the second BS 112 may use a connection identifier (CID) to identify each data link.

In a conventional art, a range of a CID may be determined based on the relays 121, 122, 123, 124, 125, and 126 connected to each of the first BS 111 and the second BS 112. For example, CIDs from a first CID to a 200^{th} CID may be assigned by the base station to data links through the first relay 121, and CIDs from a 201^{th} CID to a 400^{th} CID may be assigned by the base station to data links through the second relay 122.

In this case, however, when a number of data links through the first relay 121 is greater than 200, a new CID may not be assigned. Also, a CID may be routinely assigned to each of the relays 121, 122, 123, 124, 125, and 126. Accordingly, when a number of MSs 131, 132, 133, 134, and 135, connected to the relays 121, 122, 123, 124, 125, and 126, changes, management of the CIDs may not be actively performed.

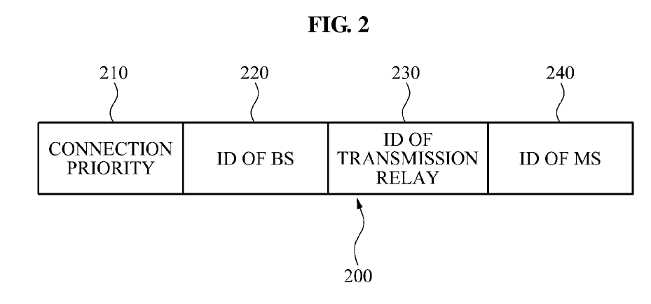

FIG. 2 is a diagram illustrating a configuration of a CID 200 according to an exemplary embodiment of the present invention.

The CID 200 may include a connection priority field 210, an ID of a BS field 220, an ID of a transmission relay field 230, and an ID of an MS field 240.

The ID of the BS field 220 may indicate an ID of a BS where an MS transmitting data is located in an entire data transmission system.

The ID of the MS field 240 may indicate an ID of the MS transmitting the data.

The ID of the transmission relay field 230 may indicate an ID of a transmission relay forwarding the data, transmitted by the MS, to the BS. Multiple relays may forward data. Thus, this field 230 may indicate more than one transmission relay.

Referring to FIG. 1, the third MS 133 may transmit data to the first BS 111 through the sixth relay 126 and the first relay 121. In this instance, the sixth relay 126 first receiving the data from the third MS 133 may be a transmission relay. That is, the transmission relay may indicate a relay directly connected to an MS among the relays.

In general, a data transmission system may be in a pyramid shape having a base station, such as the first BS 111 and the second BS 112, as a vertex. That is, the number of BSs 111 and 112 and the number of relays 121, 122, 123, 124, and 125 directly connected to the BSs 111 and 112 may be generally fewer in comparison with the number of MSs in the data transmission system. Similarly, the number of MSs 131, 132, 133, 134, 135, and 136 and the number of relays 121, 122, 123, 124, 125, and 126 directly connected to the MSs 131, 132, 133, 134, 135, and 136 may be generally greater in comparison with the number of BSs and relays in the data transmission system.

Accordingly, a data transmission link may be defined using IDs of the BSs 111 and 112, IDs of the transmission relays 121, 122, 123, 124, 125, and 126, and IDs of the MSs 131, 132, 133, 134, 135, and 136. Also, a particular data transmission link may be distinguished from other data transmission links.

The CID 200 may include the connection priority field 210. The connection priority may be determined based on a number of relays to transmit data. For example, referring to FIG. 1, the first MS 131 may transmit data to the first BS 111 through the relay 121 only. However, the third MS 133 may transmit data to the first BS 111 through two relays 121 and 126. In this case, the third MS 133 transmitting the data through a greater number of relays may have a lower connection priority than the first MS 131 transmitting the data through one relay.

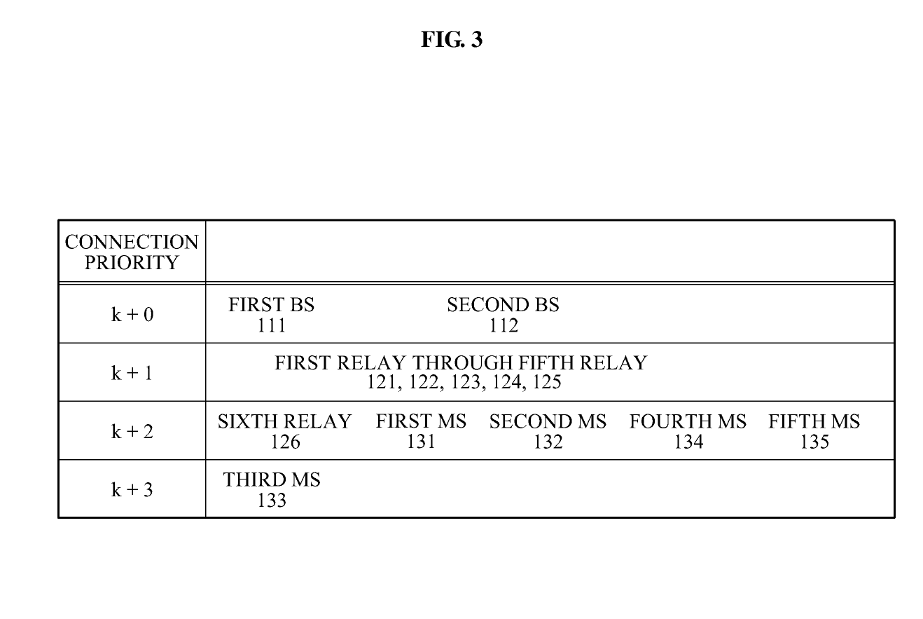

FIG. 3 is a diagram illustrating an example of a connection priority according to an exemplary embodiment of the present invention.

According to FIG. 3, the connection priority may be set with respect to a relay as well as an MS. Also, each BS may have a predetermined connection priority.

The first BS 111 and the second BS 112 may have a highest connection priority according to the data transmission system illustrated in FIG. 1. For convenience of description, it may be assumed that a connection priority assigned to the first BS 111 and the second BS 112 is k, and a smaller k indicates a higher connection priority.

The relays 121, 122, 123, 124, and 125 may have a connection priority of k+1. In this instance, the relays 121, 122, 123, 124, 125 may be directly connected to a base station, such as first BS 111 and second BS 112, having a connection priority of k, and may transmit/receive the data to/from the BSs 111 and 112. Although not shown, an MS directly connected to a base station, such as first BS 111 and second BS 112, may also have a connection priority of k+1.

Also, the sixth relay 126 and the MSs 131, 132, 134, and 135 may have a connection priority of k+2. In this instance, the sixth relay 126 and the MSs 131, 132, 134, and 135 may be directly connected to the relays having the connection priority of k+1, and transmit the data to the BSs 111 or 112 through the relays having the connection priority of k+1.

Also, the third MS 133 may have a connection priority of k+3. The third MS 133 may be connected to the sixth relay 126 having the connection priority of k+2, and transmit the data to the first BS 111 through the sixth relay 126.

As illustrated in FIG. 3, the connection priority of each of the relays 121, 122, 123, 124, 125, and 126 and each of the MSs 131, 132, 133, 134, and 135 may be determined based on a number of relays in a data link to transmit data.

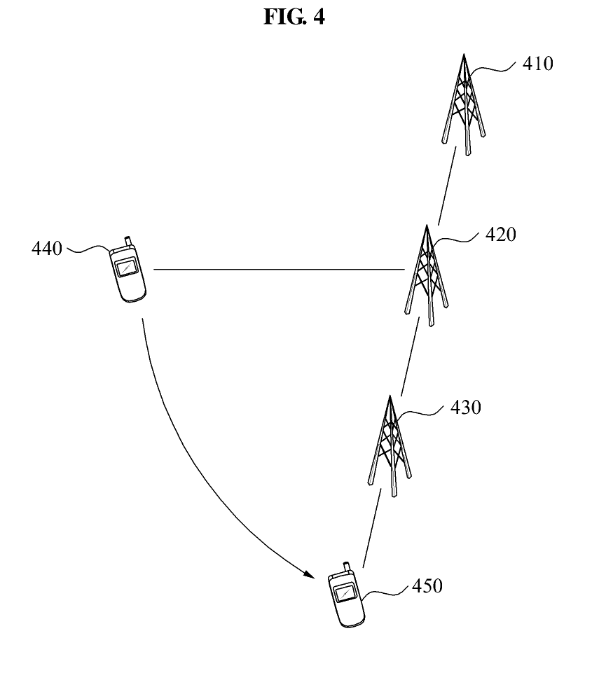

FIG. 4 is a diagram illustrating an example of reassigning a CID when an MS moves within a coverage according to an exemplary embodiment of the present invention.

An MS 440 may initially transmit data to a BS 410 through a first relay 420. Then, the MS 440 may move within a coverage of the BS 410. When the MS 440 moves to a coverage of a second relay 430 from a coverage of a first relay 420, the MS 440 may perform a handover to the second relay 430 from the first relay 420.

A data link before the MS 440 performs handover may include the MS 440, the first relay 420, and the BS 410. In this instance, a CID to identify the data link may include an ID of the MS 440, an ID of the first relay 420, and an ID of the BS 410.

A data link after the MS performs handover (labeled MS 450) may include the MS 450, the second relay 430, the first relay 420, and the BS 410. In this instance, a CID to identify the data link may include an ID of the MS 450, an ID of the second relay 430, an ID of the first relay 420, and an ID of the BS 410.

A new CID is to be assigned to the MS 450 since a handover is performed to the second relay 430 from the first relay 420. In the example illustrated in FIG. 4, the second relay 430 may assign a new CID reflecting the new data link, and the MS 450 may transmit data to the BS 410 through the first relay 420 and the second relay 430 using the assigned new CID.

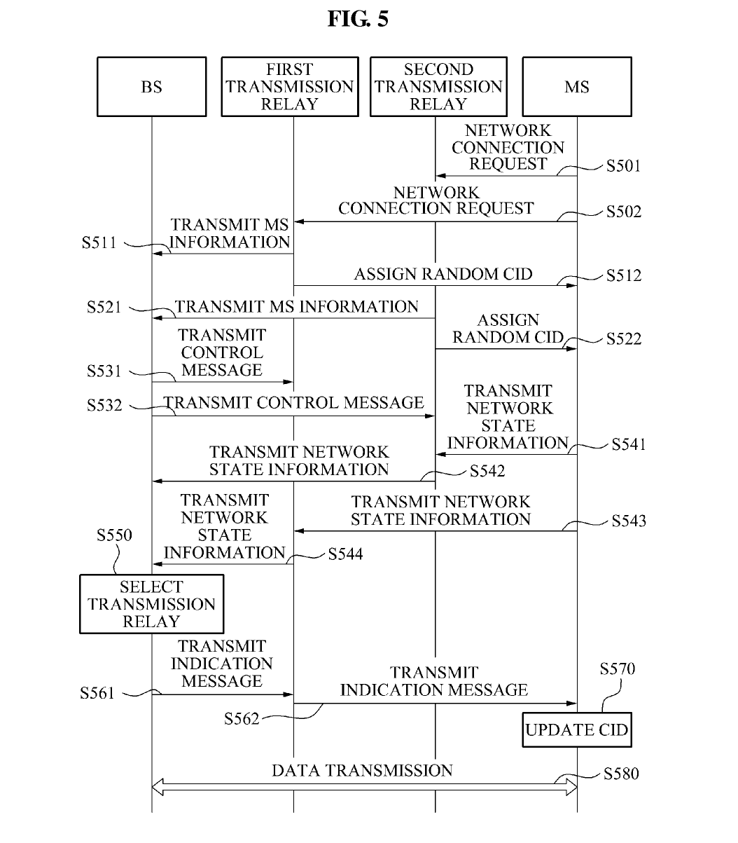

FIG. 5 is a flowchart illustrating a CID assignment method according to an exemplary embodiment of the present invention.

In operation S501, an MS may transmit a network connection request to a second transmission relay. In operation S502, the MS may transmit the network connection request to a first transmission relay. Each of the network connection requests may include a current connection priority of the MS and an ID of the MS.

In operation S511, the first transmission relay may transmit MS information to a BS. In operation S512, the first transmission relay may assign a temporary CID to the MS in response to the network connection request. Also, the first transmission relay may transmit physical channel information of the temporary CID to the BS (not shown).

In operation S521, the second transmission relay may transmit MS information to the BS. In operation S522, the second transmission relay may assign a temporary CID to the MS in response to the network connection request. Also, the second transmission relay may transmit physical channel information of the temporary CID to the BS (not shown).

The temporary CIDs in operations S512 and S522 may each include an ID of the BS, an ID of each transmission relay, and an ID of the MS.

In operations S512 and S522, the MS may update the physical channel information of each of the temporary CIDs.

Further, in operations S512 and S522, each transmission relay may compare its own connection priority with a connection priority of the MS, and determine whether to assign the temporary CID to the MS based on a result of the comparison.

For example, each transmission relay may assign the temporary CID when the connection priority of the transmission relay is higher than the connection priority of the MS.

Thus, if the connection priority of the first transmission relay is higher than the connection priority of the MS, and the connection priority of the second transmission relay is lower than the connection priority of the MS, only the first transmission relay may assign the temporary CID to the MS.

Each transmission relay may transmit its own connection priority to the MS. The MS may first use the temporary CID received from the transmission relay with a highest connection priority from among the temporary CIDs.

Hereinafter, it may be assumed that the MS first uses the first transmission relay and the temporary CID received from the first transmission relay.

In operations S512 and S522, the MS may receive the temporary CIDs from the first transmission relay and the second transmission relay.

In operation S531, the BS may transmit a control message to the first transmission relay. In operation S532, the BS may transmit a control message to the second transmission relay.

In operation S541, the MS may transmit network state information to the second transmission relay. In operation S542, the second transmission relay may transmit the network state information to the BS.

In operation S543, the MS may transmit network state information to the first transmission relay. In operation S544, the first transmission relay may transmit the network state information to the BS.

The network state information may include information that may affect selection of a data transmission link, such as a current state of each transmission relay, information about whether to assign resources, and the like.

In operation S550, the BS may select a transmission relay to receive data from the MS from among the first transmission relay and the second transmission relay based on the network state information received in operation S542 and operation S544.

It may be assumed that the BS selects the first transmission relay in FIG. 5.

Since the MS first uses the first transmission relay, the MS, the first transmission relay, and the BS may set a data transmission link.

In operation S561, the BS may transmit an indication message to the first transmission relay. In operation S562, the first transmission relay receiving the indication message may forward the indication message to the MS.

As noted above, before operation S570, the MS first used the first transmission relay and the temporary CID received from the first transmission relay. In operation S570, the MS may set a data transmission link using the first transmission relay and the temporary CID received from the first transmission relay.

The MS may update the temporary CID received from the first transmission relay with a CID, and remove the temporary CID received from the second transmission relay.

In operation S580, the MS may transmit the data using the data transmission link among the MS, the first transmission relay, and the BS.

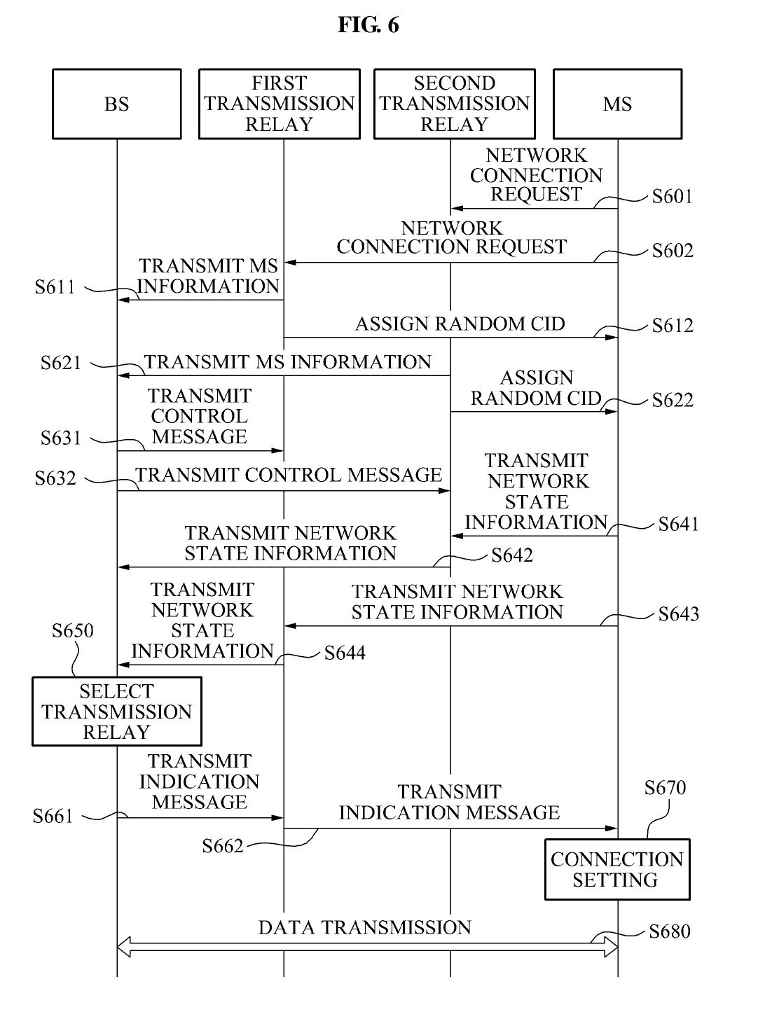

FIG. 6 is a flowchart illustrating a CID assignment method according to an exemplary embodiment of the present invention.

Since operations of a BS, a first transmission relay, a second transmission relay, and an MS in operations S601 through S644 are similar to the operations described in operations S501 through S544, detailed descriptions of the operations in operations S601 through S644 are omitted. As noted above, after operation S622 and operation S624, it is assumed that the MS first uses the temporary CID received from the first transmission relay.

Now, unlike the method described with respect to FIG. 5, in FIG. 6 it may be assumed that the BS selects the second transmission relay as a relay to receive data from the MS in operation S650.

If the MS has already been using the first transmission relay, additional operations are performed to receive the data using the second transmission relay.

In operation S661, the BS may transmit an indication message to the second transmission relay. In operation S662, the second transmission relay may transmit the indication message to the MS.

In operation S670, the MS receiving the indication message may disconnect the first transmission relay which has been used. Also, the MS may connect to the second transmission relay using physical channel information received in operation S622.

Also, the MS may update the temporary CID, received from the second transmission relay, with a CID, and remove the temporary CID received from the first transmission relay.

In operation S680, the MS may transmit data using the CID and a data transmission link among the MS, the second transmission relay, and the BS.

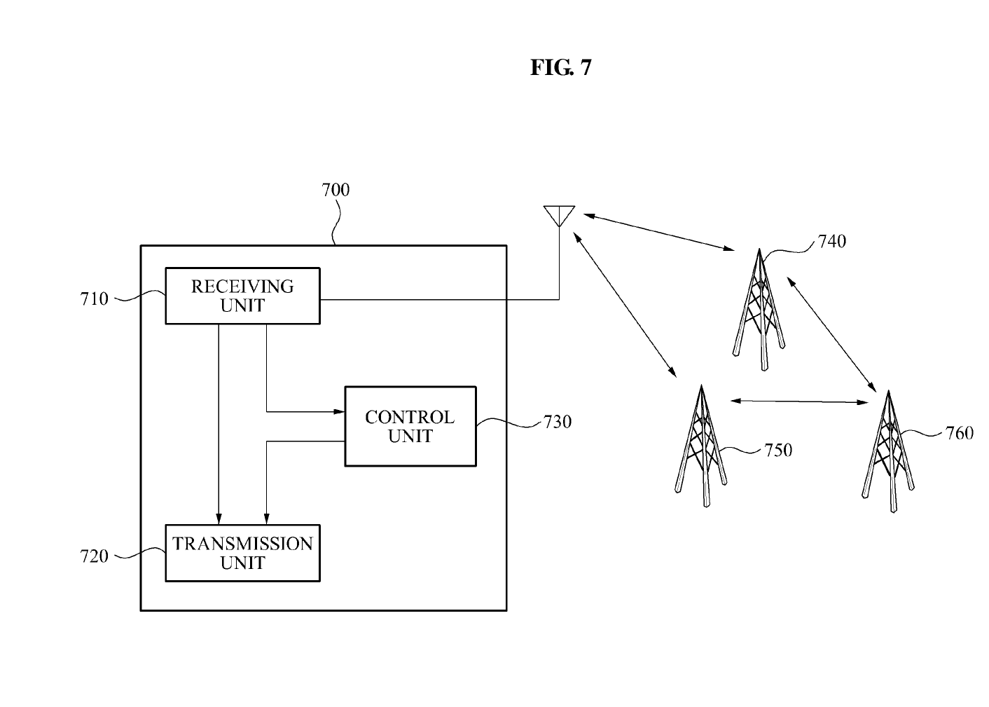

FIG. 7 is a block diagram illustrating a configuration of a mobile station according to an exemplary embodiment of the present invention.

Referring to FIG. 7, an MS 700 may include a receiving unit 710, a transmission unit 720, and a control unit 730.

The receiving unit 710 may receive a CID from a transmission relay 740 connected to a BS 760. The CID may include an ID of the BS 760 and an ID of the transmission relay 740. The CID may further include an ID of the MS 700.

The transmission unit 720 may distinguish a data transmission link among the MS 700, the transmission relay 740, and the BS 760 from another data transmission link using the CID. The other data transmission link may be a data transmission link among the MS 700, a different transmission relay 750, and the BS 760.

The transmission unit 720 may transmit data to the BS 760 through the transmission relay 740 based on the CID.

The transmission unit 720 may relay the data through at least one relay including the transmission relay 740. In this case, the CID may include connection priority of the MS 700. The connection priority may be determined based on a number of relays forwarding the data.

The transmission unit 720 may transmit a network connection request to the transmission relay 740, and the transmission relay 740 may assign the CID to the MS 700 in response to the network connection request.

The receiving unit 710 may receive the CID from each transmission relay 740 and 750. In this case, the control unit 730 may select a CID, and transmit the data.

The transmission unit 720 may transmit network state information of each transmission relay 740 and 750 to the BS 760 through the transmission relays 740 and 750. The network state information may include information that may affect selection of the data transmission link such as a current state of each of the transmission relays 740 and 750, information about whether to assign resources, and the like.

The BS 760 may select a transmission relay based on the network state information. Hereinafter, it may be assumed that the BS 760 selects the transmission relay 740.

The receiving unit 710 may receive an indication message from the BS 760. The control unit 730 may select the relay 740 as the transmission relay based on the indication message. Also, the control unit 730 may select a CID corresponding to the selected transmission relay 740, and remove other CIDs.

The transmission unit 720 may transmit the data to the BS 760 through the transmission relay 740 using the selected CID.

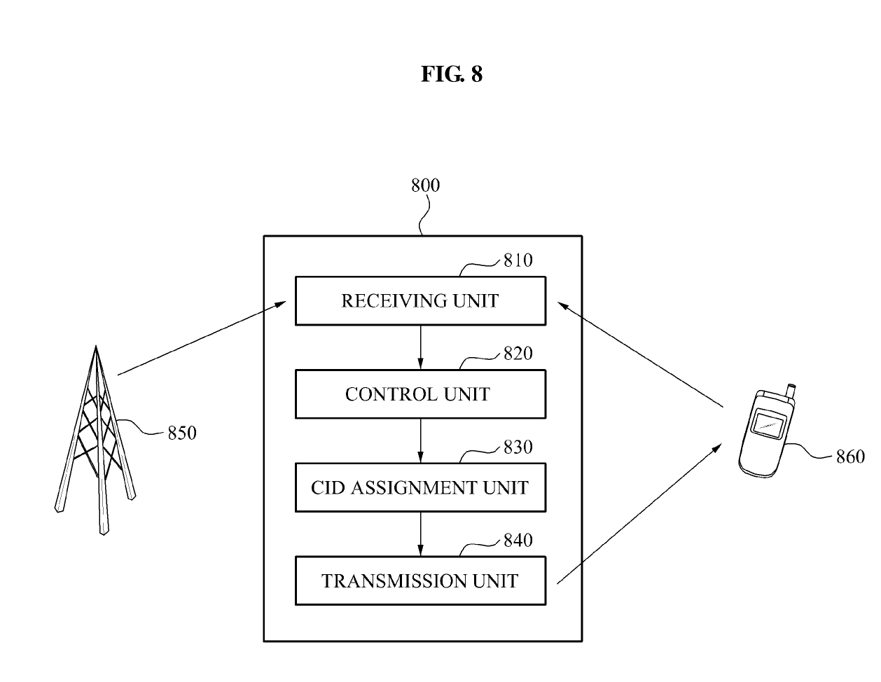

FIG. 8 is a block diagram illustrating a configuration of a transmission relay according to an exemplary embodiment of the present invention.

Referring to FIG. 8, a transmission relay 800 may include a receiving unit 810, a control unit 820, a CID assignment unit 830, and a transmission unit 840.

The CID assignment unit 830 may assign a CID to an MS 860. The CID may include an ID of a BS 850 and an ID of the transmission relay 800.

The transmission unit 840 may transmit the assigned CID to the MS 860.

The MS 860 may transmit first data to the transmission relay 800 using the CID. The receiving unit 810 may receive the first data from the MS 860, and the transmission unit 840 may forward the received first data to the BS 850.

Also, the BS 850 may transmit second data to the transmission relay 800 using the CID. The receiving unit 810 may receive the second data from the BS 850, and the transmission unit 840 may forward the received second data to the MS 860.

The receiving unit 810 may receive a network connection request from the MS 860, and the CID assignment unit 830 may assign the CID in response to the network connection request.

The transmission unit 840 may have a connection priority. The connection priority may be determined based on a number of relayed transmissions to the BS 850. When the transmission relay 800 is to transmit data to the BS 850 through multiple relays, the transmission relay 800 may have a lower connection priority. Conversely, when the transmission relay 800 is directly connected to the BS 850 or transmits the data to the BS 850 through a smaller number of relays, the transmission relay 800 may have a higher connection priority. That is, the connection priority of the transmission relay 800 may be determined based on a number of relays that receives the data from the transmission relay 800 and forwards the data to the BS 850.

The network connection request may include a connection priority of the MS 860. In this instance, the control unit 820 may compare the connection priority of the transmission relay 800 with the connection priority of the MS 860.

For example, the control unit 820 may assign the CID to the MS 860 only if the connection priority of the transmission relay 800 is higher than the connection priority of the MS 860.

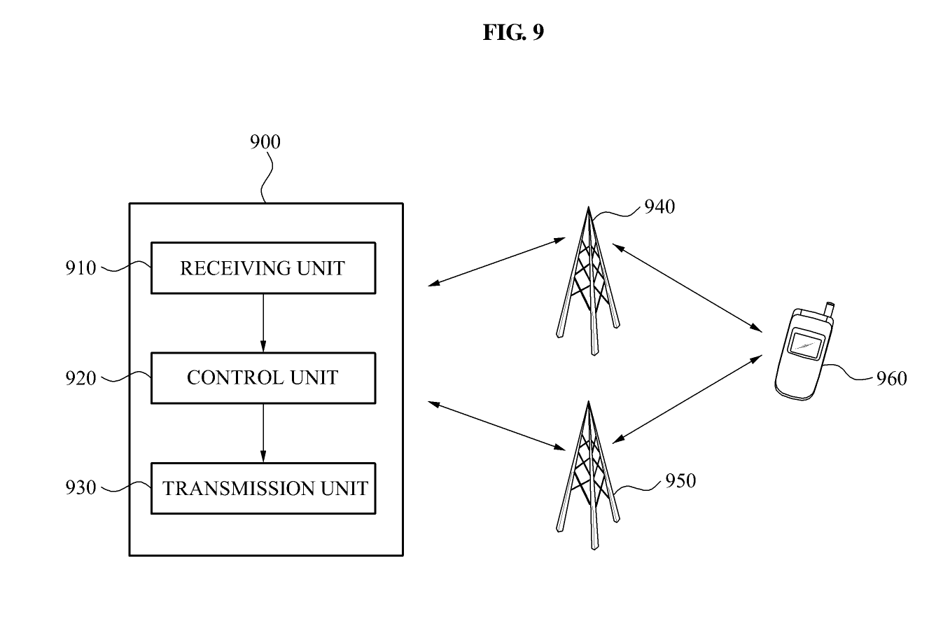

FIG. 9 is a block diagram illustrating a configuration of a base station according to an exemplary embodiment of the present invention.

Referring to FIG. 9, a BS 900 may include a receiving unit 910, a control unit 920, and a transmission unit 930.

The receiving unit 910 may receive first data from an MS 960 through a first transmission relay 940.

The transmission unit 930 may identify a data transmission link among the BS 900, the first transmission relay 940, and the MS 960 using a CID. The CID may include an ID of the first transmission relay 940 and an ID of the BS 900. Also, the transmission unit 930 may transmit second data to the MS 960 using the identified data transmission link.

The CID may further include an ID of the MS 960.

The transmission relay 940 may assign the CID according to a request from the MS 960. If each transmission relay 940 and 950 receives a request from the MS 960, each transmission relay 940 and 950 may assign a CID to the MS 960. Accordingly, multiple CIDs may be assigned to the single MS 960.

The MS 960 may transmit the CIDs to the BS 900 through each transmission relay 940 and 950. The receiving unit 910 may receive the CIDs from the MS 960 through each transmission relay 940 and 950, and the control unit 920 may select one transmission relay from the transmission relays 940 and 950.

Hereinafter, it may be assumed that the control unit 920 selects the transmission relay 940.

In this case, the transmission unit 930 may transmit an indication message to the MS 960. The indication message may include information about the selected transmission relay 940. The MS 960 may select one CID in response to the indication message, and remove the other CIDs.

The receiving unit 910 may receive data from the MS 960 based on the selected CID.

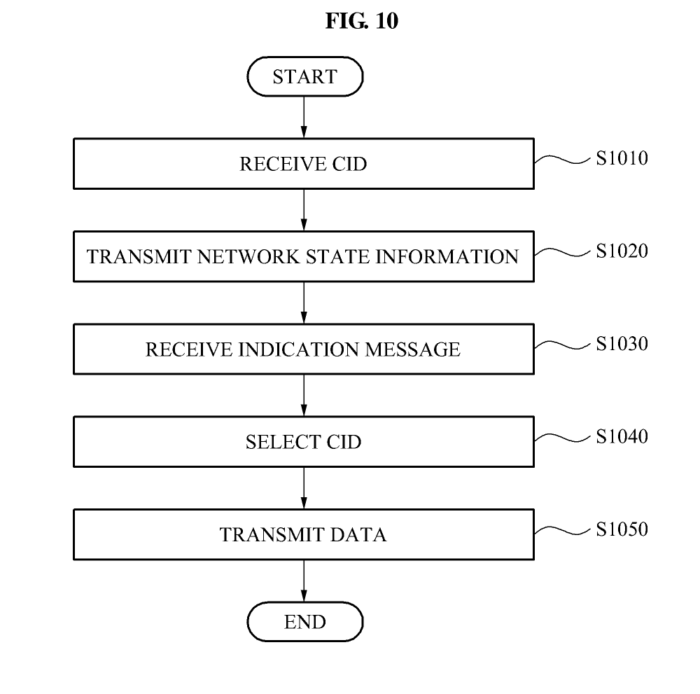

FIG. 10 is a flowchart illustrating a data transmission method according to an exemplary embodiment of the present invention.

In operation S1010, an MS may receive a CID from a transmission relay connected to a BS. The CID may include an ID of the BS and an ID of the transmission relay. The CID may further include an ID of the MS.

The MS may receive the CID from multiple transmission relays in operation S1010.

In operation S1020, the MS may transmit network state information about each of the transmission relays to the BS. The network state information may include information that may affect selection of a data transmission link, such as a current state of each of the transmission relays, information about whether to assign resources, and the like.

The BS may select one transmission relay based on the network state information.

In operation S1030, the MS may receive an indication message from the BS. The indication message may include information about the selected transmission relay.

In operation S1040, the MS may select one transmission relay based on the indication message. The transmission relay selected by the MS may be the same transmission relay selected by the BS. The MS may select a CID corresponding to the selected transmission relay in operation S1040.

In operation S1050, the MS may transmit data to the BS through the selected transmission relay based on the selected CID.

Further, in operation S1050, the MS may transmit the data through at least one relay including a transmission relay.

The CID may also include information about a connection priority determined based on a number of relays.

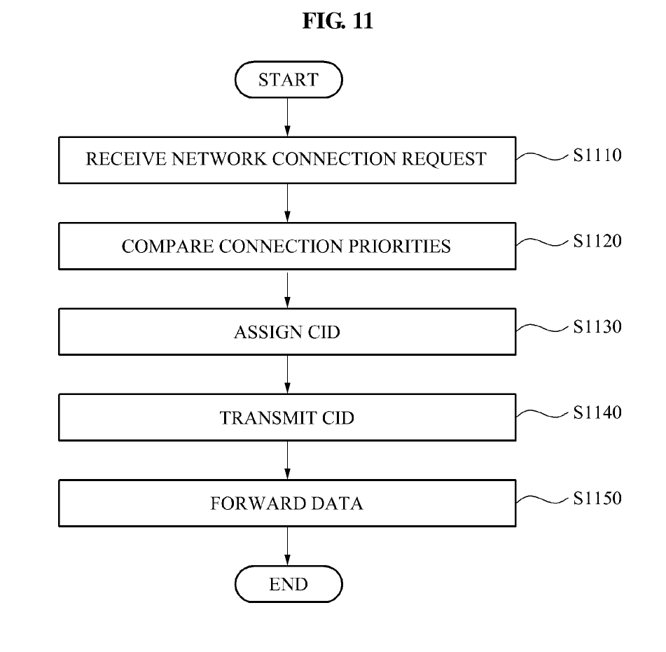

FIG. 11 is a flowchart illustrating a data forwarding method according to an exemplary embodiment of the present invention.

In operation S1110, a transmission relay may receive a network connection request from an MS. The network connection request may include a connection priority of the MS.

In operation S1120, the transmission relay may compare a connection priority of the transmission relay and the connection priority of the MS. The transmission relay may receive data from a BS through a relay. As the number of relays through which the data is passing increases, the connection priority of the transmission relay may decrease. That is, the connection priority of the transmission relay may be determined based on a number of relayed transmissions from the BS.

In operation S1130, the transmission relay may assign a CID to the MS in response to the network connection request.

The transmission relay may determine whether to assign the CID based on a result of the comparing. For example, the transmission relay may assign the CID to the MS only if the connection priority of the transmission relay is higher than the connection priority of the MS.

The CID may include an ID of the BS and an ID of the transmission relay. The CID may further include an ID of the MS.

In operation S1140, the transmission relay may transmit the CID to the MS.

In operation S1150, the transmission relay may receive the data, transmitted based on the CID, from the BS, and forward the received data to the MS based on the CID.

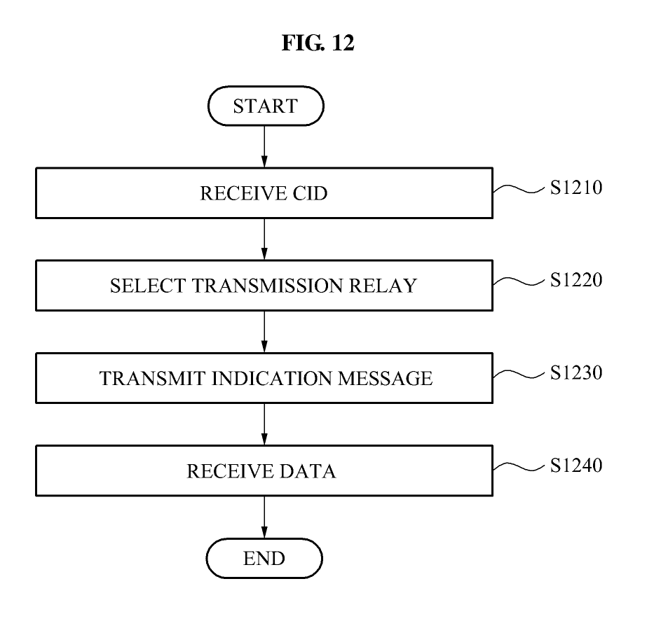

FIG. 12 is a flowchart illustrating a data receiving method according to an exemplary embodiment of the present invention.

In operation S1210, a BS may receive a CID from a transmission relay. The CID may include an ID of the BS and ID of the transmission relay. The CID may further include an ID of an MS.

The BS may receive a CID from multiple transmission relays. Each CID may include an ID of a transmission relay transmitting the CID.

In this case, the BS may receive network state information about each transmission relay. The network state information may include information that may affect selection of a data transmission link, such as a current state of each of the transmission relays, information about whether to assign resources, and the like.

In operation S1220, the BS may select a transmission relay from among the transmission relays. The BS may select the transmission relay based on the network state information.

In operation S1230, the BS may transmit an indication message to the MS. The indication message may include information about the selected transmission relay. The MS may select any one transmission relay from among the transmission relays according to the indication message. Also, the MS may select a CID corresponding to the selected transmission relay.

In operation S1240, the BS may receive data from the MS using the selected CID. The data may be transmitted using the transmission relay selected in operation S1220.

The above-described embodiments may be recorded in computer-readable media including program instructions to implement various operations when executed by a computer. The media may also include, alone or in combination with the program instructions, data files, data structures, and the like. Examples of computer-readable media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile station, comprising:
a receiving unit to receive a connection identifier (CID) from a first transmission relay connected to a base station, the CID assigned by the first transmission relay and comprising an ID of the base station and ID of the first transmission relay; and
a transmission unit to transmit data to the base station through the first transmission relay based on the CID.

2. The mobile station of claim 1, wherein the CID further comprises an ID of the mobile station.

3. The mobile station of claim 1, wherein the transmission unit transmits the data through a plurality of transmission relays including the first transmission relay, and the CID comprises connection priority determined based on a number of transmission relays.

4. The mobile station of claim 1, further comprising:
a control unit,
wherein the receiving unit receives a plurality of temporary CIDs from a plurality of transmission relays, respectively,
the transmission unit transmits network state information about each transmission relay to the base station through the transmission relays, respectively, and
the control unit selects the first transmission relay from among the plurality of transmission relays according to an indication message received from the base station, and selects the CID corresponding to the first transmission relay.

5. A transmission relay connected to a base station, the transmission relay comprising:
a connection identifier (CID) assignment unit to assign a CID to a mobile station, the CID comprising an ID of the base station and an ID of the transmission relay; and
a transmission unit to transmit the CID to the mobile station and to transmit data to the mobile station based on the CID, the data being received from the base station.

6. The transmission relay of claim 5, further comprising:
a receiving unit to receive a network connection request from the mobile station,
wherein the CID assignment unit assigns the CID in response to the network connection request.

7. The transmission relay of claim 6, wherein the network connection request comprises a connection priority of the mobile station.

8. The transmission relay of claim 7, further comprising:
a control unit,
wherein the receiving unit receives the data from the base station using at least one relay, a connection priority of the transmission relay is determined based on a number of relays, and the control unit compares the connection priority of the transmission relay and the connection priority of the mobile station to determine whether to assign the CID.

9. The transmission relay of claim 8, wherein the control unit assigns the CID if the connection priority of the transmission relay is higher than the connection priority of the mobile station.

10. A base station, comprising:
a receiving unit to receive first data from a mobile station through a first transmission relay connected to the base station; and
a transmission unit to transmit second data to the mobile station using a connection identifier (CID) assigned by the first transmission relay and comprising an ID of the first transmission relay and an ID of the base station.

11. The base station of claim 10, wherein the CID further comprises an ID of the mobile station.

12. The base station of claim 10, further comprising:
a control unit,
wherein the receiving unit receives a plurality of temporary CIDs from the mobile station through a plurality of transmission relays, respectively, the control unit selects the first transmission relay from among the plurality of transmission relays, and the transmission unit transmits an indication message to the mobile station, the indication message including information about the first transmission relay.

13. A data transmission method, comprising:
receiving a connection identifier (CID) from a first transmission relay connected to a base station, the CID assigned by the first transmission relay and comprising an ID of the base station and ID of the first transmission relay; and
transmitting data to the base station through the first transmission relay based on the CID.

14. The data transmission method of claim 13, wherein the CID further comprises an ID of a mobile station.

15. The data transmission method of claim 13, wherein the data is transmitted through a plurality of transmission relays including the first transmission relay, and the CID comprises connection priority determined based on a number of transmission relays.

16. The data transmission method of claim 13, further comprising:
transmitting network state information about a plurality of transmission relays to the base station through the transmission relays, respectively;
selecting the first transmission relay from among the plurality of transmission relays according to an indication message received from the base station; and
selecting the CID corresponding to the first transmission relay,
wherein a temporary CID is received from each transmission relay.

17. A data forwarding method, comprising:
at a transmission relay connected to a base station, assigning a connection identifier (CID) to a mobile station, the CID comprising an ID of the base station and an ID of the transmission relay;
transmitting the CID to the mobile station; and
forwarding data received from the base station to the mobile station based on the CID.

18. The data forwarding method of claim 17, further comprising:
receiving a network connection request comprising a connection priority of the mobile station from the mobile station,
wherein the CID is assigned in response to the network connection request.

19. The data forwarding method of claim 18, further comprising:
comparing a connection priority of the transmission relay and the connection priority of the mobile station, and determining whether to assign the CID,
wherein the data is received from the base station using at least one relay, and the connection priority of the transmission relay is determined based on a number of relays.

20. A data receiving method, comprising:
receiving a connection identifier (CID) from a transmission relay connected to a base station, the CID assigned by the transmission relay and comprising an ID of the base station and ID of the transmission relay; and
receiving data from a mobile station through the transmission relay using the CID.

21. The data receiving method of claim 20, wherein the CID further comprises an ID of the mobile station.

22. The data receiving method of claim 20, further comprising:
selecting a first transmission relay from among a plurality of transmission relays; and
transmitting an indication message comprising information about the first transmission relay to the mobile station,
wherein a plurality of temporary CIDs are received from the mobile station through the plurality of transmission relays, respectively.

23. A computer-readable recording medium storing a program for implementing a data transmission method, comprising:
receiving a connection identifier (CID) from a transmission relay connected to a base station, the CID assigned by the transmission relay and comprising an ID of the base station and ID of the transmission relay; and
transmitting data to the base station through the transmission relay based on the CID.

24. A computer-readable recording medium storing a program for implementing a data forwarding method, comprising:
at a transmission relay connected to a base station, assigning a connection identifier (CID) to a mobile station, the CID comprising an ID of the base station and an ID of the transmission relay;
transmitting the CID to the mobile station; and
forwarding data received from the base station to the mobile station based on the CID.

25. A computer-readable recording medium storing a program for implementing a data receiving method, comprising:
receiving a connection identifier (CID) from a transmission relay connected to a base station, the CID assigned by the transmission relay and comprising an ID of the base station and ID of the transmission relay; and
receiving data from a mobile station through the transmission relay using the CID.
